(19) United States
(12) Patent Application Publication
(10) Pub. No.: US 2024/0270618 A1
(43) Pub. Date: Aug. 15, 2024

(54) RENEWABLE NATURAL GAS AND CARBON DIOXIDE CAPTURING SYSTEM AND RELATED METHODS

(71) Applicant: Cambrian Innovation,Inc., Watertown, MA (US)

(72) Inventors: Zhen Huang, Watertown, MA (US); Matthew Silver, Watertown, MA (US); QuynhAnh Tran, Watertown, MA (US)

(73) Assignee: Cambrian Innovation, Inc., Watertown, MA (US)

(21) Appl. No.: 18/438,511

(22) Filed: Feb. 11, 2024

Related U.S. Application Data
(60) Provisional application No. 63/444,899, filed on Feb. 10, 2023.

(51) Int. Cl. C02F 3/12; C01B 32/50; C02F 3/00; C02F 3/28; C10L 3/10

(52) U.S. Cl. CPC C02F 3/1268; C01B 32/50; C02F 3/006; C02F 3/28; C10L 3/103; C10L 3/104; C02F 2209/02; C02F 2209/03; C02F 2209/06; C02F 2209/40

(57) ABSTRACT

Systems and related methods generate renewable natural gases and capture CO₂ using a combination of technologies, including, but not limited to, an anaerobic treatment process, a membrane bioreaction process, a biogas upgrading process, and a CO₂ purification process.

### RELATED APPLICATION

The present application is related to, and claims priority from, U.S. provisional application No. 63/444,899 filed Feb. 10, 2023 (the “'899 Application”). The present application incorporates by reference the entire disclosure, including drawings, of the '899 Application as if the '899 Application were set forth in full herein.

### FIELD

The present disclosure relates to systems and related methods for generating renewable natural gases and capturing carbon dioxide.

### INTRODUCTION

There exist industrial facilities that produce wastewater that must be treated before any water can be re-used or stored. Such wastewater may produce large amounts of carbon dioxide (CO₂), methane and other biogases during treatment. It is desirable to process and capture such biogases as renewable natural gases for re-use or storage rather than release such biogases to the surrounding environment.

### SUMMARY

The present disclosure sets forth exemplary embodiments of systems and related methods that generate renewable natural gases and capture CO₂ using a combination of technologies, including, but not limited to, an anaerobic treatment process, a membrane bioreaction process, a biogas upgrading process, and a CO₂ purification process, for example.

One exemplary method for capturing carbon dioxide may comprise: receiving, at a purifier, one or more of the following, an off-gas comprising carbon dioxide, carbon dioxide from a biogas upgrading system, and a gas comprising carbon dioxide from a membrane bioreactor; and purifying a total amount of received carbon dioxide from one or more of the off-gas, biogas upgrading system and membrane bioreactor. Further, such a method may comprise: (a) purifying the total amount of received carbon dioxide to about 99.99% CO2; and/or (b) outputting the purified carbon dioxide; and/or (c) outputting the purified carbon dioxide for re-use or for storage; and/or (d) controlling a flow of carbon dioxide into, and out of, the purifier.

In embodiments, the membrane bioreactor used in such an exemplary method may comprise a combined aerobic digester coupled to a membrane filtration element that is configured to convert organic residue in an aqueous stream into a mixture of air and carbon dioxide.

Still further, such an exemplary method may comprise outputting a purified water stream.

Another exemplary method may comprise a method for capturing carbon dioxide and natural gas. Such a method may comprise: receiving a mixture of biogases from a bioreactor; removing hydrogen sulfide and moisture from the received biogases; and separating mixed methane and carbon dioxide from the received biogases into separate methane and carbon dioxide gas streams.

In such a method may generate a carbon dioxide gas stream that is about 98% carbon dioxide.

Such a method may further comprise: (i) outputting the carbon dioxide stream to a purifier; and/or (ii) generating a methane stream that is about 97% methane; and/or (iii) outputting a methane stream.

The bioreactor of such an exemplary method may comprise an anaerobic treatment zone, for example, among other zones.

The present disclosure also discloses yet another exemplary method. For example, a method for controlling the purification of carbon dioxide and wastewater is disclosed. Such an exemplary method may comprise: controlling a flow of carbon dioxide into, and out of, a purifier; controlling an input of wastewater into industrial equipment; and controlling an output of biogases and treated wastewater from an anaerobic subsystem.

This method may further comprise: (A) controlling the flow of carbon dioxide, input of wastewater or output of biogases by exchanging electrical control signals or measured data via dedicated or shared communication links with one or more subsystems, where, for example, the measured data may comprise pH, pressures, temperatures, and flow rates; and/or (B) determining an amount of biogas produced; and/or (C) determining an amount of methane produced by one or more subsystems; and/or (D) determining an efficiency of one or more of the subsystems.

The present disclosure also discloses complimentary devices, systems and apparatuses for completing the exemplary methods described above and elsewhere herein.

### BRIEF DESCRIPTION OF THE DRAWINGS

FIG. 1 depicts an exemplary block diagram of a system for generating renewable natural gases and capturing CO2 according to embodiments of the invention.

### DETAILED DESCRIPTION, WITH EXAMPLES

As used herein, the words “comprising”, and any form thereof such as “comprise” and “comprises”; “having”, and any form thereof such as “have” and “has”; “including”, and any form thereof such as “includes” and “include”; and “containing” and any form thereof such as “contains” and “contain” are inclusive or open-ended and do not exclude additional, unrecited elements or process steps.

As used herein, the term “stream” can include various molecules in liquid or gas state, and can include mixtures of gases, liquids, and particulate solids. Generally, a stream can be a wastewater stream or a biogas stream containing methane.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

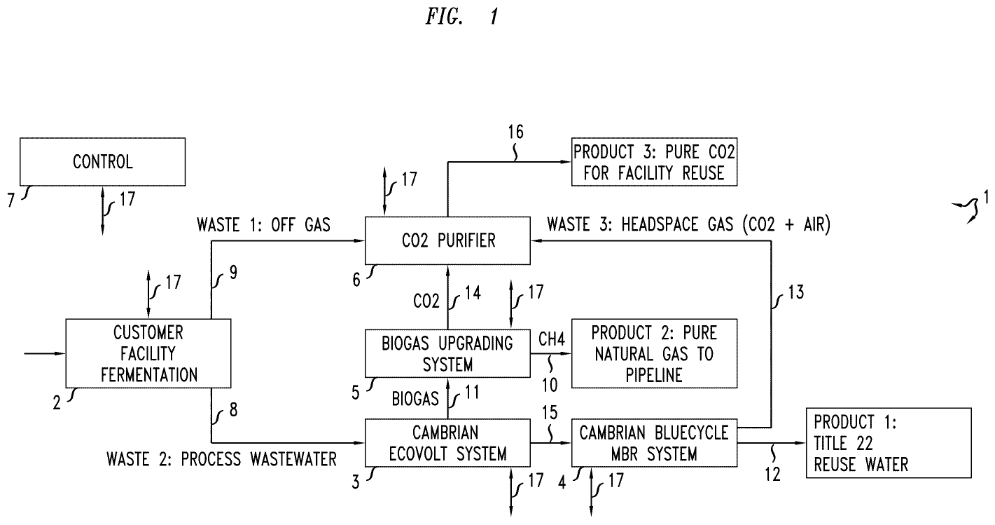

As depicted, process flow lines in FIG. 1 may be referred to as a connection, where a connection may comprise a line, pipe, input, output, feed, or stream, for example.

As used herein the terms “exemplary” or “embodiment” mean one example of the inventive disclosure.

As used herein, the term “about” or “approximately” is defined as being close to or near as understood by one of ordinary skill in the art, and in some embodiments may be quantified as within 10%, more particularly within 5%, still more particularly within 1%, and is in some cases within 0.5%.

As used herein, the term “a” or “an” when used in conjunction with the term comprising or a form thereof may mean “one”, but is also consistent with the meaning of “one or more”, “at least one”, and “one or more than one”.

As used herein, the “biological oxygen demand” may be abbreviated “BOD”.

As used herein, the term “coupled” can mean two items, directly or indirectly, joined, fastened, associated, supported, connected, attached, or formed integrally together either by chemical or mechanical means, by processes including stamping, molding, or welding. What is more, two items can be coupled using a third component such as a mechanical fastener, e.g., a screw, a nail, a staple, or a rivet; an adhesive; or a solder.

It should be understood at the outset that although an exemplary implementation of at least one embodiment of the present disclosure is illustrated below, the systems/devices/apparatuses described herein may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

As used herein the term “controller” means an electronic or electromechanical device that includes one or more electronic processors. Each processor may retrieve computer program code (e.g., electronic instructions) from one or more non-tangible electronic memories (e.g., database, a USB memory stick, CD-ROM or a DVD Other forms of tangible storage media may be used.

When used in an apparatus/system/device, a controller may be configured with at least one processor and at least one electronic memory that includes computer program code, the at least one memory and the computer program code being configured to, with the at least one processor, cause the apparatus/system/device at least to complete one or more features and/or process/method steps described herein.

The present invention relates to systems and related methods for combining and treating aqueous and gaseous waste streams using multiple elements/components to produce purified methane and carbon dioxide gases and reusable water streams.

Referring to FIG. 1, an exemplary system 1 can be coupled to industrial equipment 2 that uses water. Generally, the equipment 2 can be part of a wastewater treatment facility, a chemical or petrochemical manufacturing facility, a fermentative food or beverage product producer, or an agricultural waste processing plant to name just a few examples.

In embodiments, during operation equipment 2 may output fermentation byproducts, such as CO₂. Such fermentation off gas may be input into, and received by, a CO₂ purifier subsystem 6 of system 1 via a first connection 9 (e.g., piping) while wastewater may be output via connection 8 (e.g., again piping) and input into other subsystems of the system 1 to be processed as described herein. In an embodiment, the wastewater may include associated biogases as well, such as CH₄ (e.g., about 65%) and CO₂ (e.g., about 35%), for example.

In an embodiment, the purifier subsystem 6 may receive one or more of the following as described herein: an off-gas comprising carbon dioxide, carbon dioxide from a biogas upgrading system, and a gas comprising carbon dioxide from a membrane bioreactor. Thereafter the purifier subsystem 6 may purify a total amount of received carbon dioxide from one or more of the off-gas, biogas upgrading system and membrane bioreactor.

The subsystems of system 1 may include a combination of gas and liquid handling subsystems (e.g., reactors) that support biochemical and electrochemical reactions and may include membranes to produce near-pure carbon dioxide, methane, and water products that comply with at least California's Title 22 water standards, for example.

For example, one subsystem may be a bioreactor 3 (e.g., the EcoVolt™ system made by Cambrian Innovation, Inc.) configured to receive the wastewater from the equipment 1 via connection 8, and generate biogas, for example.

In an embodiment, the bioreactor 3 may comprise two bioreaction zones, including but not limited to, an anaerobic treatment zone, that upon treating the wastewater outputs a mixture of biogases (e.g., carbon dioxide and methane) to a biogas upgrading subsystem 5 via connection 11 and aqueous wastewater containing residual organic matter to a membrane bioreactor 4 (MBR) (e.g., a Cambrian BlueCycle™ MBR) via connection 10.

The biogas upgrading subsystem 5 may be configured to remove hydrogen sulfide (H₂S) and moisture, separate the mixed methane and carbon dioxide into separate methane and CO₂gas streams. In an embodiment, the subsystem 5 may generate a CO₂ stream that is about 98% CO₂ and a renewable methane stream that is about 97% methane, for example. Further, the subsystem 5 may output the methane stream to a pipeline or storage facility via connection 15 while the CO₂ may be output to a CO₂ purifier subsystem 6 via connection 14, for example.

The MBR 4 may comprise a combined aerobic digester coupled to a membrane filtration element that is configured to convert organic residue in the aqueous stream within connection 10 into a mixture of air and CO₂. Such a mixture may be output to a CO₂ purifier subsystem 6 through connection 13, for example. In addition, the MBR 4 may output a purified water stream (e.g., water that satisfies at least California's Title 22 water standards, for example) via connection 12 that may be re-used by the equipment 2 or user operating equipment 2, for example, or stored in storage tanks (not shown in FIG. 1).

As noted above, the CO₂ purifier subsystem 6 may receive three gaseous streams that contain CO₂ from three different sources: one stream from the equipment 2, one from the MBR 4 and one from the biogas upgrading system 5.

In an embodiment, upon receiving CO₂ from each of the three sources the CO₂ purifier subsystem 6 may be configured to purify the total amount of received CO₂ to about 99.99% CO₂ (e.g., “purified CO₂”) and output the purified CO₂ to the equipment 2 for re-use or to a storage tank, for example, via connection 16.

Further, in embodiments, the flow of CO₂ into, and out of, the CO₂ purifier subsystem 6 may be controlled by a control subsystem 7 by exchanging electrical control signals and measured data with elements of subsystem 6 (e.g., sensors, valves—not shown) of each respective subsystem via dedicated or shared communication link 17.

In more detail, the control subsystem 7 may be configured with at least one electronic processor and memory that stores electrical instructions (e.g., firmware, software) which when triggered by measured data or a fixed or variable threshold(s) may cause the processor to execute the stored instructions to analyze, determine and/or modify the operating parameters for each subsystem of system 1, thereby controlling the process of capturing carbon dioxide (CO2), among other processes.

In addition to controlling the CO₂ purifier 6 (and thus the CO₂ purification process), the control subsystem 7 may be operable to control the initial input of wastewater into equipment 2, as well as the output of biogases and treated wastewater from the anaerobic subsystem 3 by exchanging electrical control signals and measured data with elements (e.g., sensors, valves—not shown) of each respective subsystem via dedicated or shared communication links 17, for example.

Still further, the control subsystem 7 may be configured to execute stored instructions to control subsystems 2 through 6 by similarly exchanging electrical control signals and/or measured data via dedicated or shared communication links 17, for example.

In embodiments, the measured data may comprise pH, pressures, temperatures, flow rates while exemplary analysis may comprise executable instructions for determining a compositional analysis, determination of volatile fatty acids and biological oxygen demands (BOD) of the wastewater. The control subsystem 7 may be configured to execute stored instructions to determine the amount of biogas produced by the subsystems 2 through 7 including, but not limited to the amount of methane produced which, optionally, can be transmitted from the control subsystem 7 and used for accounting purposes, for example. Moreover, the control subsystem 7 may additionally execute stored instructions to determine the efficiency of one or more elements of the system 1 or equipment 2 by, for example, measuring the amount or absence of recycled biogas.

We claim:

1. A method for capturing carbon dioxide comprising:
receiving, at a purifier, one or more of the following,
an off-gas comprising carbon dioxide,
carbon dioxide from a biogas upgrading system, and
a gas comprising carbon dioxide from a membrane bioreactor; and
purifying a total amount of received carbon dioxide from one or more of the off-gas, biogas upgrading system and membrane bioreactor.

2. The method as in claim 1 further comprising purifying the total amount of received carbon dioxide to about 99.99% CO2.

3. The method as in claim 1 further comprising outputting the purified carbon dioxide.

4. The method as in claim 1 further comprising outputting the purified carbon dioxide for re-use or for storage.

5. The method as in claim 1 further comprising controlling a flow of carbon dioxide into, and out of, the purifier.

6. The method as in claim 1 wherein the membrane bioreactor comprises a combined aerobic digester coupled to a membrane filtration element configured to convert organic residue in an aqueous stream into a mixture of air and carbon dioxide.

7. The method as in claim 6 further comprising outputting a purified water stream.

8. A method for capturing carbon dioxide and natural gas comprising:
receiving a mixture of biogases from a bioreactor;
removing hydrogen sulfide and moisture from the received biogases; and
separating mixed methane and carbon dioxide from the received biogases into separate methane and carbon dioxide gas streams.

9. The method as in claim 8 further comprising generating the carbon dioxide gas stream that is about 98% carbon dioxide.

10. The method as in claim 8 further comprising outputting the carbon dioxide stream to a purifier.

11. The method as in claim 8 further comprising generating the methane stream that is about 97% methane.

12. The method as in claim 8 further comprising outputting the methane stream.

13. The method as in claim 8 wherein the bioreactor comprises an anaerobic treatment zone.

14. A method for controlling the purification of carbon dioxide and wastewater comprising:
controlling a flow of carbon dioxide into, and out of, a purifier;
controlling an input of wastewater into industrial equipment; and
controlling an output of biogases and treated wastewater from an anaerobic subsystem.

15. The method as in claim 14 further comprising controlling the flow of carbon dioxide, input of wastewater or output of biogases by exchanging electrical control signals or measured data via dedicated or shared communication links with one or more subsystems.

16. The method as in claim 14 wherein the measured data comprises pH, pressures, temperatures, and flow rates.

17. The method as in claim 14 further comprising determining an amount of biogas produced.

18. The method as in claim 17 further comprising determining an amount of methane produced by one or more subsystems.

19. The method as in claim 18 further comprising determining an efficiency of one or more of the subsystems.
